(19) United States
(12) Patent Application Publication
(10) Pub. No.: US 2025/0148550 A1
(43) Pub. Date: May 8, 2025

(54) SERVER APPARATUS

(71) Applicant: TOYOTA JIDOSHA KABUSHIKI KAISHA, Aichi-ken (JP)

(72) Inventor: Sachio TOYORA, Gotemba-shi (JP)

(21) Appl. No.: 18/934,240

(22) Filed: Nov. 1, 2024

(30) Foreign Application Priority Data
Nov. 8, 2023 (JP) 2023-191061

(51) Int. Cl. G06Q 50/06; B60L 53/64; B60L 53/66; G06Q 40/04

(52) U.S. Cl. CPC G06Q 50/06; B60L 53/64; B60L 53/665; G06Q 40/04

(57) ABSTRACT

A server apparatus includes a communication interface, and a controller configured to communicate using the communication interface, and transmit, when a power sale price corresponding to a predetermined electrical energy of a battery of a vehicle is equal to or higher than a power purchase price corresponding to the predetermined electrical energy, permission information to enable sale of power of the predetermined electrical energy from the battery.

### CROSS-REFERENCE TO RELATED APPLICATION

This application claims priority to Japanese Patent Application No. 2023-191061, filed on Nov. 8, 2023, the entire contents of which are incorporated herein by reference.

### TECHNICAL FIELD

The present disclosure relates to a server apparatus.

### BACKGROUND

The concept of a community Energy Management System (EMS) is being developed in communities managed by local governments, companies, and the like for management, as a whole, of the charging and discharging of various power sources scattered throughout the community, the power supply from the power grid of an electricity provider, and the power demand occurring within the community. Various technologies have been proposed to manage the electric power supply and demand in a community. Power sources in the community include electric automobiles traveling within the community as well as power generation facilities located within the community. Patent Literature (PTL) 1 discloses a technology for controlling the charging and discharging of electric automobiles. In addition, PTL 2 discloses a technology for controlling power sources in a community in response to a request from an electricity provider.

### CITATION LIST

### Patent Literature

PTL 1: JP 2018-207590 A
PTL 2: JP 6997289 B2

### SUMMARY

Compensation is charged when the battery of an electric automobile is charged or discharged to supply power to the grid of an electricity provider. In other words, when charging, the user of the electric automobile pays for the power required for charging, and when discharging, the user obtains compensation from the grid for the power to be discharged. Here, there is room for improving convenience for the user of the electric automobile.

The present disclosure relates to a server apparatus or the like that enables to improve convenience for a user of an electric automobile.

A server apparatus in the present disclosure includes:
a communication interface; and
a controller configured to:
   communicate using the communication interface; and
   transmit, when a power sale price corresponding to a predetermined electrical energy of a battery of a vehicle is equal to or higher than a power purchase price corresponding to the predetermined electrical energy, permission information to enable sale of power of the predetermined electrical energy from the battery.

According to the server apparatus or the like in the present disclosure, it is possible to improve convenience for a user of an electric automobile.

### BRIEF DESCRIPTION OF THE DRAWINGS

In the accompanying drawings:

FIG. 1 is a diagram illustrating an example configuration of an information processing system;

FIG. 2 is a sequence diagram illustrating an operation example of the information processing system; and

FIG. 3 is a sequence diagram illustrating an operation example of the information processing system.

### DETAILED DESCRIPTION

Embodiments are described below.

### [Configuration of System]

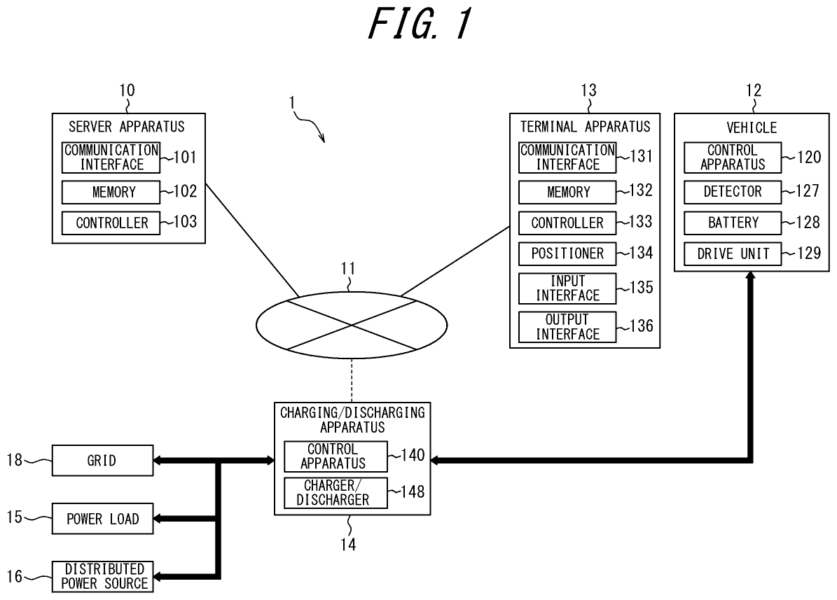

FIG. 1 is a diagram illustrating a configuration example of an information processing system according to an embodiment. An information processing system 1 supports the efficient trading of electricity by communities with electricity providers. A community is any town or regional unit managed by a municipality, company, or the like. Within the community, charging/discharging apparatuses 14 are distributed to charge and discharge the power of vehicles 12 driven by battery power. In addition to charging the vehicles 12, electricity is consumed in the community by various power loads 15 installed in residences, commercial facilities, etc., such as appliances, lighting, and air conditioning equipment. The electricity consumed in the community is purchased from the grid 18 of the electricity provider or generated by distributed power sources 16 such as solar, wind, and other alternative energy generators, fuel cells, and storage batteries. The surplus electricity generated in the community is sold (sale of power) to the grid 18. The purchase of electricity by a vehicle 12 is borne by the rightful owner of the vehicle 12, e.g., the user or owner (hereinafter referred to as the user in general). The profit from the sale of power by the vehicle 12 is enjoyed by the user of the vehicle 12. The information processing system 1 includes one or more each of a server apparatus 10, a vehicle 12, a terminal apparatus 13, and a charging/discharging apparatus 14 communicably connected to each other via a network 11. The server apparatus 10 controls charging (purchase of power) from the grid 18 to the vehicle 12 and discharging (sale of power) from the vehicle 12 to the grid 18 via the charging/discharging apparatus 14, depending on the supply and demand of electricity in the community.

The server apparatus 10 is, for example, a server computer that belongs to a cloud computing system or other computing system and operates as a community EMS (CEMS) server and a vehicle information server that manages information on the vehicle 12. The vehicle 12 is a passenger car, a multipurpose vehicle, or the like equipped with control and communication functions and driven by battery power, such as a battery electric vehicle (BEV), a hybrid electric vehicle (HEV), or a plug-in hybrid electric vehicle (PHEV). The terminal apparatus 13 is an information processing apparatus with communication functions used by the user of the vehicle 12, such as a smartphone or tablet terminal. The network 11 is, for example, the Internet, but may include an ad hoc network, a LAN, a metropolitan area network (MAN), or other networks, or any combination thereof. The charging/discharging apparatus 14 is a charging/discharging station installed in a community, includes a charging/discharging stand to which the vehicle 12 electrically connects, and is configured to communicate with the server apparatus 10 via the network 11. Information on the operation of the power loads 15 and the distributed power sources 16 scattered throughout the community is transmitted and received to and from the server apparatus 10 via the network 11 by the power conditioners, smart meters, and the like that are connected to the network 11 and configured to communicate information.

In the present embodiment, the server apparatus 10 includes a communication interface 101 and a controller 103 that communicates using the communication interface 101. The controller 103 transmits permission information to enable the sale of power from a battery 128 of the vehicle 12 to the grid 18 when the power sale price to sell power to the grid 18 corresponding to a predetermined electrical energy in the battery 128 is equal to or higher than the power purchase price to purchase power from the grid 18. Based on such permission information, the discharge from the vehicle 12 to the grid 18 via the charging/discharging apparatus 14 allows the user of the vehicle 12 to benefit from the excess of the power purchase price over the power sale price, or at least to prevent overspending on power purchase. Therefore, it is possible to improve convenience for the user of the electric automobile.

### [Configuration of Server Apparatus 10]

The server apparatus 10 includes the communication interface 101, a memory 102, and the controller 103. The server apparatus 10 is, for example, a single server computer. The server apparatus 10 may be two or more computers that are communicably connected to each other and operate in cooperation. In this case, the configuration illustrated in FIG. 1 can be arranged among two or more computers as appropriate.

The communication interface 101 includes one or more interfaces for communication. The interface for communication is, for example, a LAN interface. The communication interface 101 receives information to be used for the operations of the server apparatus 10 and transmits information obtained by the operations of the server apparatus 10. The server apparatus 10 is connected to the network 11 by the communication interface 101 and communicates information with the vehicle 12 or the charging/discharging apparatus 14 via the network 11.

The memory 102 includes, for example, one or more semiconductor memories, one or more magnetic memories, one or more optical memories, or a combination of at least two of these types, to function as main memory, auxiliary memory, or cache memory. The semiconductor memory is, for example, Random Access Memory (RAM) or Read Only Memory (ROM). The RAM is, for example, Static RAM (SRAM) or Dynamic RAM (DRAM). The ROM is, for example, Electrically Erasable Programmable ROM (EEPROM). The memory 102 stores information to be used for the operations of the server apparatus 10 and information obtained by the operations of the server apparatus 10.

The controller 103 includes one or more processors, one or more dedicated circuits, or a combination thereof. The processor is a general purpose processor, such as a central processing unit (CPU), or a dedicated processor, such as a graphics processing unit (GPU), specialized for a particular process. The dedicated circuit is, for example, a field-programmable gate array (FPGA), an application specific integrated circuit (ASIC), or the like. The controller 103 executes information processing related to operations of the server apparatus 10 while controlling components of the server apparatus 10.

The functions of the server apparatus 10 are realized by a processor included in the controller 103 executing a control program. The control program is a program for causing a computer to execute the processing of steps included in the operations of the server apparatus 10, thereby enabling the computer to realize the functions corresponding to the processing of the steps. That is, the control program is a program for causing a computer to function as the server apparatus 10. Some or all of the functions of the server apparatus 10 may be realized by a dedicated circuit included in the controller 103. The control program may be stored on a non-transitory recording/storage medium readable by the server apparatus 10 and be read from the medium by the server apparatus 10.

### [Configuration of Terminal Apparatus 13]

The terminal apparatus 13 includes a communication interface 131, a memory 132, a controller 133, a positioner 134, an input interface 135, and an output interface 136. The terminal apparatus 13 is, for example, an information processing apparatus such as a smartphone, a tablet terminal, or the like.

The communication interface 131 includes a communication module compliant with a wired or wireless LAN standard, a module compliant with a mobile communication standard such as Long Term Evolution (LTE), 4th Generation (4G), or 5th Generation (5G), or the like. The terminal apparatus 13 connects to the network 11 via a nearby router apparatus or mobile communication base station using the communication interface 131 and communicates information with other apparatuses over the network 11.

The memory 132 includes, for example, one or more semiconductor memories, one or more magnetic memories, one or more optical memories, or a combination of at least two of these types. The semiconductor memory is, for example, RAM or ROM. The RAM is, for example, SRAM or DRAM. The ROM is, for example, EEPROM. The memory 132 functions as, for example, a main memory, an auxiliary memory, or a cache memory. The memory 132 stores information to be used for the operations of the controller 133 and information obtained by the operations of the controller 133.

The controller 133 has one or more general purpose processors such as CPUs or micro processing units (MPUs) or one or more dedicated processors that are dedicated to specific processing. Alternatively, the controller 133 may have one or more dedicated circuits such as FPGAs or ASICs. The controller 133 is configured to perform overall control of the operations of the terminal apparatus 13 by operating according to the control/processing programs or operating according to operating procedures implemented in the form of circuits. The controller 133 then transmits and receives various types of information to and from the server apparatus 10 and the like via the communication interface 131 and executes the operations according to the present embodiment.

The positioner 134 includes one or more Global Navigation Satellite System (GNSS) receivers. The GNSS includes, for example, at least one of Global Positioning System (GPS), Quasi-Zenith Satellite System (QZSS), BeiDou, Global Navigation Satellite System (GLONASS), and Galileo. The positioner 134 acquires the positional information for the terminal apparatus 13 and transmits the positional information to the controller 133.

The input interface 135 includes one or more interfaces for input. The interface for input includes, for example, a physical key, a capacitive key, a pointing device, a touch screen integrally provided with the display, a camera that captures images or image codes, or an IC card reader. The interface for input may include a microphone that accepts audio input. The input interface 135 accepts input of information to be used in the operations of the controller 133 and transmits the inputted information to the controller 133.

The output interface 136 includes one or more interfaces for output. The interface for output is, for example, a display or a speaker. The display is, for example, a Liquid Crystal Display (LCD) or an organic Electro Luminescent (EL) display. The output interface 136 outputs information obtained by the operations of the controller 133.

The functions of the controller 133 are realized by a processor included in the controller 133 executing a control program. The control program is a program for causing the processor to function as the controller 133. Some or all of the functions of the controller 133 may be realized by a dedicated circuit included in the controller 133.

### [Configuration of Vehicle 12]

The vehicle 12 includes a control apparatus 120, the battery 128, and a drive unit 129 driven by electricity from the battery 128, and the vehicle 12 travels by operation of the drive unit 129 under control by the control apparatus 120. The control apparatus 120 has a configuration equivalent to the communication interface 131, the memory 132, the controller 133, the positioner 134, the input interface 135, and the output interface 136 of the terminal apparatus 13 and includes, for example, an Electronic Control Unit (ECU). The control apparatus 120 may be configured by two or more apparatuses, including a communication device. The communication device includes a data communication module (DCM), for example. The control apparatus 120 may be configured to include a personal computer, a smartphone, a tablet terminal, a navigation apparatus, or the like. The battery 128 is, for example, a lithium-ion battery. The drive unit 129 includes a motor for driving the drive wheels, braking mechanism, and other such components; a control circuit for the motor; and the like. The vehicle 12 further has a detector 127. The detector 127 includes sensors that detect the level of the battery 128 and the temperature, current value, and the like of the motor in the drive unit 129. The components are communicably connected to each other, or to other devices and apparatuses in the vehicle 12, by an in-vehicle network compliant with standards such as a controller area network (CAN). The control apparatus 120 performs various information processing to control various parts of the vehicle 12 based on information received from the detector 127.

### [Configuration of Charging/Discharging Apparatus 14]

The charging/discharging apparatus 14 includes a control apparatus 140 and a charger/discharger 148. The control apparatus 120 has a configuration equivalent to the communication interface 131, the memory 132, the controller 133, the input interface 135, and the output interface 136 of the terminal apparatus 13. The charger/discharger 148 includes a charging/discharging station that has a connector and feeder cable that connect to an inlet of the vehicle 12, a switch for opening and closing the connection of the power line to a power load 15 in the community or to the grid 18, a battery or capacitor for storing electricity, and the like. The charger/discharger 148 can switch the switch, in response to an instruction from the control apparatus 140, to charge the battery 128 of the vehicle 12 with electricity supplied from the grid 18 or to supply electricity discharged from the battery 128 of the vehicle 12 to the power load 15 or to the grid 18.

### [Operations of Information Processing System 1]

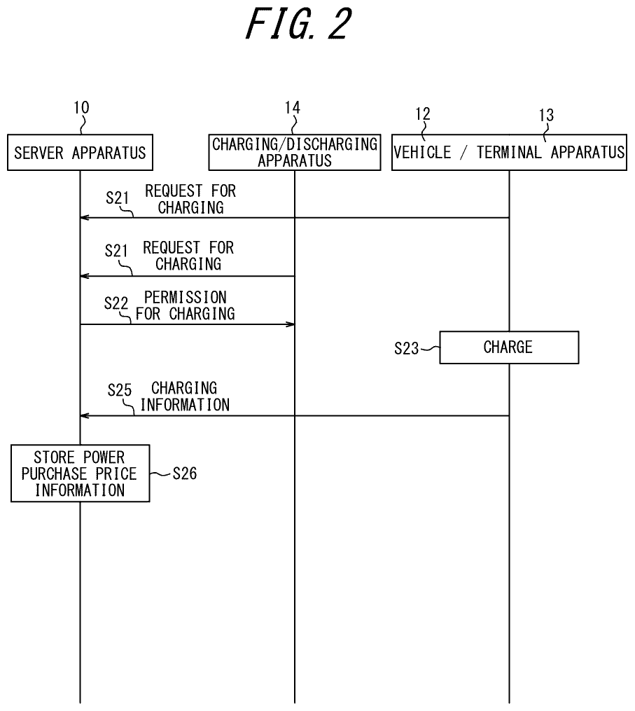

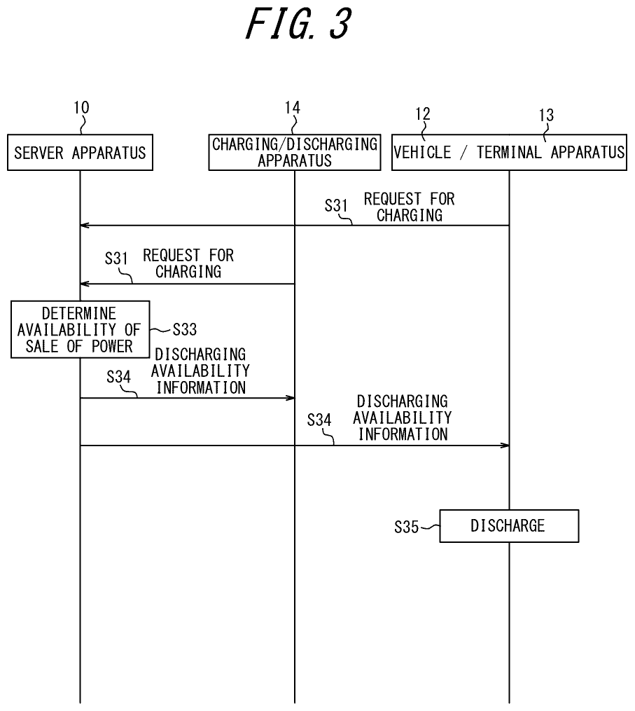

FIG. 2 and FIG. 3 are sequence diagrams illustrating an operation example of the information processing system 1. FIG. 2 and FIG. 3 illustrate the procedures for coordinated operation by the server apparatus 10, the vehicle 12, the terminal apparatus 13, and the charging/discharging apparatus 14. In FIG. 2 and FIG. 3, the steps pertaining to the various information processing by the server apparatus 10, the vehicle 12, the terminal apparatus 13, and the charging/discharging apparatus 14 are performed by the respective controllers 103 or 133. The steps pertaining to transmitting and receiving various types of information to and from the server apparatus 10, the vehicle 12, the terminal apparatus 13, and the charging/discharging apparatus 14 are performed by the respective controllers 103 or 133 transmitting and receiving information to and from each other via the respective communication interfaces 101 or 131. In the server apparatus 10, the vehicle 12, the terminal apparatus 13, and the charging/discharging apparatus 14, the respective controllers 103 or 133 appropriately store the information that is transmitted and received in the respective memories 102 or 132. Furthermore, the respective controllers 133 of the vehicle 12, the terminal apparatus 13, and the charging/discharging apparatus 14 accept input of various information by the input interfaces 135 and output various information by the output interfaces 136.

The procedure in FIG. 2 is performed, for example, when a user of the vehicle 12 charges the battery 128 of the vehicle 12.

In step S21, the vehicle 12 or the terminal apparatus 13 transmits information on a request for charging to the server apparatus 10. The request for charging is information requesting permission to charge the vehicle 12 and includes identifying information that identifies the user and the vehicle 12. The control apparatus 120 of the vehicle 12 or the terminal apparatus 13, for example, displays a screen prompting the user to enter identification information and a request for charging. The user inputs, for example, identification information, information on a request for charging, etc., by touch operation to the touch panel. The identification information may be stored in the memory 132 in advance. The control apparatus 120 or the terminal apparatus 13 transmits a request for charging to the server apparatus 10, including the identification information that is input or read from the memory 132. Alternatively, the request for charging may be transmitted from the charging/discharging apparatus 14 to the server apparatus 10. For example, a user who brings the vehicle 12 to the charging/discharging station may operate the control apparatus 140 to enter information for a request for charging, and the charging/discharging apparatus 14 may transmit the request for charging.

In step S22, the server apparatus 10 transmits permission for charging to the charging/discharging apparatus 14 in response to the request for charging. The server apparatus 10 determines the source of power for charging and generates information identifying the source. The source of supply is the grid 18 or the distributed power sources 16. The permission for charging includes information to allow the charging/discharging apparatus 14 to charge, along with information identifying the source of the power.

In step S23, the vehicle 12 charges the battery 128. Charging of the vehicle 12 is performed by the charging/discharging apparatus 14, which is enabled to discharge in response to the permission for charging. In the charging/discharging apparatus 14, the control apparatus 140 charges the battery 128 of the vehicle 12 using power supplied by the grid 18 to a charger/discharger 148 or, alternatively or in addition, using power generated and supplied by the distributed power sources 16. Alternatively, the vehicle 12 may be charged by on-site power generation by the user-owned distributed power sources 16, if the user owns one of the distributed power sources 16, such as solar power, for example. In that case, steps S21 and S22 can be omitted.

In step S25, the vehicle 12 transmits charging information to the server apparatus 10. The charging information includes the identification of the vehicle 12 and information indicating the electrical energy charged (hereafter referred to as the amount of charge). In the vehicle 12, the control apparatus 120 transmits the information on the amount of charge acquired by the detector 127 to the server apparatus 10. The amount of charge is determined, for example, from the difference in the State of Charge (SOC) values before and after charging. The charging information may be sent from the control apparatus 120 of the vehicle 12 to the server apparatus 10 via the terminal apparatus 13. Alternatively, if the vehicle 12 is charged from the charging/discharging apparatus 14, the charging/discharging apparatus 14 may transmit information on the amount of charge derived from the integrated value of the current, etc. to the server apparatus 10. If the vehicle 12 is charged by on-site power generation, information indicating that the power source is on-site power generation is added to the charging information.

In step S26, the server apparatus 10 derives and stores power purchase price information for each vehicle 12. The server apparatus 10 derives the power purchase price information for each vehicle 12 identified by the identification information. The power purchase price information includes the amount of charge charged by the vehicle 12 in step S23 and its purchase price. The purchase price is determined, for example, by multiplying the unit price of electricity purchased at the time of charging (e.g., price per kWh) by the electrical energy charged. The unit price of electricity purchased at the time of charging is, for example, the unit price of electricity provided by the electricity provider or the unit price of electricity purchased from the aggregation coordinator for electricity generated by the distributed power sources 16 in the community. The server apparatus 10 acquires the unit price of purchased electricity from the servers of the electricity providers, aggregation coordinator servers, etc. The unit price of electricity purchased may, for example, vary at any given time of day, or it may vary depending on weather conditions and other conditions of power generation by the distributed power sources 16. The server apparatus 10, for example, acquires the unit price of electricity purchased during the time period from when the request for charging is received in step S21 to when the charging information is received in step S25. If the vehicle 12 is charged by its own power generation, the server apparatus 10 sets the unit price of purchased electricity to an arbitrary price (e.g., 0 yen to 50 yen/kWh). If the unit price of electricity purchased changes during the time period in which the unit price of electricity purchased is acquired, the server apparatus 10 uses, for example, a simple average of a plurality of power purchase unit prices, an average weighted by the time each price lasts. The server apparatus 10 stores the derived power purchase price information in the memory 102 by associating it with the identification information of each vehicle 12.

The procedure in FIG. 3 is performed, for example, when a user of the vehicle 12 discharges the battery 128 of the vehicle 12.

In step S31, the vehicle 12 or the terminal apparatus 13 transmits a request for discharging to the server apparatus 10. The request for discharging is information requesting permission to discharge the vehicle 12 and perform sale of power to the grid 18, and includes identification information identifying the user and the vehicle 12, and the electrical energy to be discharged (hereinafter referred to as “discharge amount”). The control apparatus 120 of the vehicle 12 or the terminal apparatus 13 displays a screen prompting the user, for example, to enter identification information, the amount of discharge, and the request for discharging. The user inputs, for example, identification information, the amount of discharge, information on a request for discharging, etc., by touch operation to the touch panel. The identification information may be stored in the memory 132 in advance. The amount of discharge may be determined, for example, from the remaining battery capacity at the current time and an arbitrary target SOC value. The control apparatus 120 or the terminal apparatus 13 transmits a request for discharging to the server apparatus 10, including the input or the identification information read from the memory 132. Alternatively, the request for discharging may be transmitted from the charging/discharging apparatus 14 to the server apparatus 10. For example, a user who brings the vehicle 12 to the charging/discharging station may operate the control apparatus 140 to enter information for a request for discharging, and the charging/discharging apparatus 14 may transmit the request for discharging.

In step S33, the server apparatus 10 determines the availability of sale of power. The server apparatus 10 determines the availability of sale of power for each vehicle 12 identified by the identification information. The server apparatus 10 determines the availability of sale of power using the discharge amount included in the request for discharging and the power purchase price information derived in step S26 of FIG. 2.

The server apparatus 10 derives the sale price obtained by the user of the vehicle 12 by discharge. The sale price is determined, for example, by multiplying the unit price of sale of power at the time of discharge (e.g., price per kWh) by the amount of discharge. The unit price of sale of power during discharge is, for example, the unit price of electricity purchased by the electricity provider or aggregation coordinator. The server apparatus 10 acquires the unit price of sale of power from the server of the electricity provider or aggregation coordinator, etc. The unit price of sale of power, for example, varies at any given time period depending on the supply and demand of electricity. The server apparatus 10, for example, acquires the unit price of sale of power during a time period of arbitrary length from the current time (e.g., the general discharge time plus an arbitrary margin of time according to the discharge amount). If the unit price of sale of power varies during the time period for acquiring the unit price of sale of power, the server apparatus 10 uses, for example, a simple average of a plurality of unit prices of sale of power, an average weighted by the time period each unit price lasts. When power is sold through an aggregation coordinator, the unit price of sale of power may vary depending on the amount of power generated by the distributed power sources 16 in the community, and since the amount of power generated by the distributed power sources 16 from sunlight depends on the weather and location, the server apparatus 10 may estimate changes in the unit price of sale of power based on one or more of the weather information, the location of the distributed power sources 16, etc., and adjust the unit price of sale of power. Weather information is acquired from a server that provides weather information.

The server apparatus 10 also derives the power purchase price of the discharged amount of electricity. The server apparatus 10 derives the unit purchase price based on the power purchase price derived in step S26 of FIG. 2. If power has been purchased in the past at a plurality of power purchase unit prices, the server apparatus 10 derives the average of the power purchase unit prices weighted by the amount of power purchased corresponding to the power purchase unit price as the power purchase unit price. The server apparatus 10 derives the power purchase price by multiplying the derived power purchase unit price by the discharge amount.

The server apparatus 10 determines that the sale of power by the user is allowed if the power sale price is equal to or higher than the power purchase price, and determines that the sale of power by the user is not allowed if the power sale price is less than the power purchase price.

In step S34, the server apparatus 10 transmits discharging availability information to the charging/discharging apparatus 14, or in addition to this to the vehicle 12 or terminal apparatus 13. The discharging availability information in the case of discharge availability includes information that enables the charging/discharging apparatus 14 to receive discharge from the vehicle 12 and information that prompts the user to perform the discharge. The control apparatus 140 of the charging/discharging apparatus 14, or in addition to this, the control apparatus 120 of the vehicle 12 or the terminal apparatus 13, presents the user that the discharge is possible and encourages the user to perform the discharge. In this case, the discharging availability information may include information on the profit on sale that the user can expect to enjoy by performing the discharge and selling the power. On the other hand, the discharging availability information in the case of discharge unavailability includes information to prohibit the charging/discharging apparatus 14 from receiving discharge from the vehicle 12 and information to urge the user to stop the discharge. The control apparatus 140 of the charging/discharging apparatus 14, or in addition to this, the control apparatus 120 of the vehicle 12 or the terminal apparatus 13, presents the user with the fact that the discharge is not possible and urges the user to stop the discharge. In this case, the discharging availability information may include information on the loss of sale that the user may suffer by performing the discharge and selling the power.

If discharge is possible, in step S35, the vehicle 12 discharges the battery 128. The vehicle 12 is discharged to the charging/discharging apparatus 14, which is now ready to receive discharge. In the charging/discharging apparatus 14, the control apparatus 140 receives the power discharged from the battery 128 of the vehicle 12 by the charger/discharger 148 and transmits it to the grid 18. If discharge is not possible, step S35 is omitted.

The above procedure allows the user of the vehicle 12 to benefit from the excess of the power sale price over the power purchase price, or at least to prevent overspending by power purchase. Therefore, it is possible to improve convenience for the user of the electric automobile.

In variation, when the server apparatus 10 determines the availability of sale of power in step S33, if an increase in the power sale price is predicted within an freely set time period based on information from the electricity provider, the server apparatus 10 generates a power sale plan, specifying any time after the power sale price increase to encourage sale of power. The server apparatus 10 then transmits the power sale plan to the vehicle 12 or the terminal apparatus 13, including the discharging availability information. In doing so, the user of the vehicle 12 will know that he/she will gain further sale profit if he/she delays the execution of the discharge to some extent. Accordingly, the convenience for the user further improves.

In another variation, when the server apparatus 10 determines the availability of sale of power in step S33, if a change in the power purchase price is predicted based on information from the electricity provider after an freely set elapsed time, it adjusts the power purchase price by taking that change into account. At the user of the vehicle 12, the need to recharge an electrical energy equivalent to the discharged amount is foreseen after the sale of power. In such cases, changes in the power purchase price when it is recharged again can increase or compress the long-term gain on sale at the user. Thus, the server apparatus 10 derives the power purchase price, for example, using the average of the past power purchase price and the expected power purchase price after discharge. By doing so, it is possible to equalize the long-term cost of buying electricity and evaluate the long-term profit from the sale expected from the sale of power by the user. Thus, it is possible to pursue gains on sale in a more detailed manner.

In the above embodiment, a processing/control program that specifies operations of the controller 133 of the control apparatus 120 of the vehicle 12, the terminal apparatus 13, or the control apparatus 140 of the charging/discharging apparatus 14 may be stored in the memory 102 of the server apparatus 10 or in the memory of another server apparatus and be downloaded onto each apparatus via the network 11. The processing/control program may also be stored on a non-transitory recording/storage medium readable by each apparatus and each apparatus may read the program from the medium.

While embodiments have been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means, each step, or the like can be rearranged without logical inconsistency, and a plurality of means, steps, or the like can be combined into one or divided.

1. A server apparatus comprising:
a communication interface; and
a controller configured to:
communicate using the communication interface; and
transmit, when a power sale price corresponding to a predetermined electrical energy of a battery of a vehicle is equal to or higher than a power purchase price corresponding to the predetermined electrical energy, permission information to enable sale of power of the predetermined electrical energy from the battery.

2. The server apparatus according to claim 1, wherein the controller is configured to transmit a power sale plan indicating a time period in which the sale of power of the predetermined electrical energy from the battery is to be performed.

3. The server apparatus according to claim 2, wherein the controller is configured to predict a change in the power sale price based on a time and/or a location at which the sale of power is to be performed, and/or a weather.

4. The server apparatus according to claim 1, wherein the controller is configured to derive the power purchase price using a price at a time when the predetermined electrical energy was charged, or a price that is predicted at a time when the predetermined electrical energy is to be purchased after the sale of power of the predetermined electrical energy.

5. The server apparatus according to claim 1, wherein the controller is configured to use, when a plurality of power sale prices corresponds to the sale of power of the predetermined electrical energy, an average of the plurality of power sale prices.
